(19) United States
(12) Patent Application Publication
(10) Pub. No.: US 2025/0356267 A1
(43) Pub. Date: Nov. 20, 2025

(54) ENVIRONMENTAL ANOMALY DETECTING SYSTEM AND METHOD THEREOF

(71) Applicant: Radiant Opto-Electronics Corporation, Kaohsiung City (TW)

(72) Inventors: Yi-Jyun LIN, Kaohsiung City (TW); Yi-Hui LIN, Kaohsiung City (TW); Li-Wei CHEN, Kaohsiung City (TW); Ming-Che TSAI, Kaohsiung City (TW)

(21) Appl. No.: 19/177,661

(22) Filed: Apr. 14, 2025

Related U.S. Application Data
(63) Continuation of application No. PCT/CN2023/143455, filed on Dec. 29, 2023.

(30) Foreign Application Priority Data
Nov. 13, 2023 (CN) 2023115011722

(51) Int. Cl. G06N 20/20; F24F 11/32; F24F 11/64; F24F 110/12; F24F 110/20; F24F 140/50

(52) U.S. Cl. CPC G06N 20/20; F24F 11/32; F24F 11/64; F24F 2110/12; F24F 2110/20; F24F 2140/50

(57) ABSTRACT

An environmental anomaly detecting system, applied to an air detection in an environment. The environmental anomaly detecting system includes: an air conditioning equipment, used for providing an air flow to the environment; at least one sensor, used for obtaining a feature data relating to the air flow; and a computing module, communicatively connecting to the at least one sensor, used for inputting the feature data into each of multiple machine learning models to obtain multiple first prediction labels. The computing module is used for inputting the multiple first prediction labels into an ensemble model to obtain a second prediction label, and the second prediction label is used for indicating whether the air flow is abnormal.

### RELATED APPLICATIONS

This application is a continuation of International application No. PCT/CN2023/143455, filed on Dec. 29, 2023, which claims priority from China Patent Application Serial Number 2023115011722, filed on Nov. 13, 2023, the content of which are incorporated herein by reference in their entireties.

### BACKGROUND

### Technical Field

The present disclosure relates to a system for detecting environmental anomaly by machine learning and a method thereof.

### Description of Related Art

The cleanroom is a specialized laboratory or manufacturing environment with extremely stringent environmental controls, mainly used in semiconductor manufacturing, biotechnology, pharmaceutical, and precision engineering industries. In the cleanroom, an air conditioning system is responsible for temperature control as well as humidity regulation, which is crucial for ensuring the success of operations and product quality. For example, during the photolithography, a slight change in the temperature may lead to changes in the properties of photoresist and further affect the pattern accuracy on the wafer. An appropriate temperature can prevent the generation of static electricity, and especially when manipulating microelectronic components. Furthermore, excessively high and low humidities may affect the progress of some chemical reactions and thereby affect the product quality. Also, the air conditioning system removes dust and particles in the air by a filter system to maintain the clean level of the cleanroom. Therefore, the air conditioning system plays a key role in the cleanroom to ensure the product quality and the stability and efficiency during the manufacturing. How to detect anomalies of air flows in environments is a critical technical issue.

### SUMMARY

One embodiment of the present disclosure directs to an environmental anomaly detecting system, applied to an air detection in an environment. The environmental anomaly detecting system includes: an air conditioning equipment, a sensor, and a computing module. The air conditioning equipment is used for providing an air flow to the environment. The sensor is used for obtaining a feature data relating to the air flow. The computing module, communicatively connecting to the sensor, is used for inputting the feature data into each of multiple machine learning models to obtain multiple first prediction labels. The computing module is used for inputting the multiple first prediction labels into an ensemble model to obtain a second prediction label, and the second prediction label is used for indicating whether the air flow is abnormal.

In accordance with some embodiments, a number of the at least one sensor is bigger than 1, and one of the sensors is deployed in an intake area of the air conditioning equipment, and the air flow enters the environment through the intake area, wherein another one of the sensors is deployed in the environment.

In accordance with some embodiments, the feature data includes a temperature and a humidity.

In accordance with some embodiments, the computing module is further used for obtaining an outdoor temperature and a load rate of the air conditioning equipment, and the feature data further includes the outdoor temperature and the load rate.

In accordance with some embodiments, the machine learning models include a clustering algorithm, a time series forecasting algorithm, and a decision tree algorithm.

In accordance with some embodiments, the computing module is used for calculating a classification indicator of each of the machine learning models in a training stage. The computing module adds a constant to the classification indicator to calculate a weight of each of the machine learning models, and the ensemble model is used for summing a multiplication of each of the weights of the machine learning models and each of the first prediction labels of the machine learning models to obtain a prediction value, and determining whether the prediction value is higher than a threshold to generate the second prediction label.

In accordance with some embodiments, the threshold is set to be less than or equal to 0.6.

In accordance with some embodiments, the threshold is set to be less than or equal to 0.3.

In accordance with some embodiments, the classification indicator is calculated according to the following equations:

$$S = \frac{1}{m} {\sum }_{i = 1}^{n} s ( i ) ,$$

$$s ( i ) = \frac{b ( i ) - a ( i )}{max ( a ( i ) , b ( i ) )} ,$$

$$a ( i ) = \frac{1}{n - 1} {\sum }_{j \neq i}^{n} distance ( i , j ) , and$$

$$b ( i ) = min ( \frac{1}{{n}_{k}} {\sum }_{{j}_{k} = 1}^{{n}_{k}} distance ( i , {j}_{k} ) , k = 1 , 2 , … ) ,$$

where S represents the classification indicator, i, j, jₖ, and k are positive integers, m represents a number of the multiple samples, n represents a number of a class to which an i^{th} sample belongs and the i^{th} sample and a j^{th} sample belong to a same class, nₖ represents a number of a kₜₕ class and the i^{th} sample and a jₖ^{th} sample belong to different classes, and distance( ) is used for calculating a distance between two samples.

In accordance with some embodiments, the computing module is used for calculating the weights according to the following equation:

$${w}_{x} = \frac{{S}_{x} + 1}{{\sum }_{x} ( {S}_{x} + 1 )} ,$$

where x is a positive integer, Sₓ is the classification indicator of a x^{th} machine learning model, and wₓ is the weight of the x^{th} machine learning model.

In some embodiments, each of the machine learning models has multiple model parameters, and the computing module is used for re-training the machine learning models and the ensemble model at every preset time interval according to a new feature data to renew the model parameters, the classification indicators, and the weights.

Another aspect of the present disclosure directs to an environmental anomaly detecting method, applied to the environmental anomaly detecting system, includes: a data capture step, obtaining the feature data of the air flow; an input step, inputting the feature data into each of the multiple machine learning models to obtain the multiple first prediction labels; and an ensemble step, inputting the multiple first prediction labels into the ensemble model to obtain the second prediction label, and the second prediction label is used for indicating whether the air flow is abnormal.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic diagram of an environmental anomaly detecting system in accordance with some embodiments of the present disclosure.

FIG. 2 is schematic flowchart of an environmental anomaly detecting method in accordance with some embodiments of the present disclosure.

FIG. 3 is a schematic operation diagram of machine learning models and an ensemble model in accordance with some embodiments of the present disclosure.

FIG. 4 and FIG. 5 are schematic diagrams of experiment results in accordance with some embodiments of the present disclosure.

### DETAILED DESCRIPTION

The terms “first”, “second”, and the like, as used herein, are not intended to mean a sequence or order, and are merely used to distinguish elements or operations described in the same technical terms.

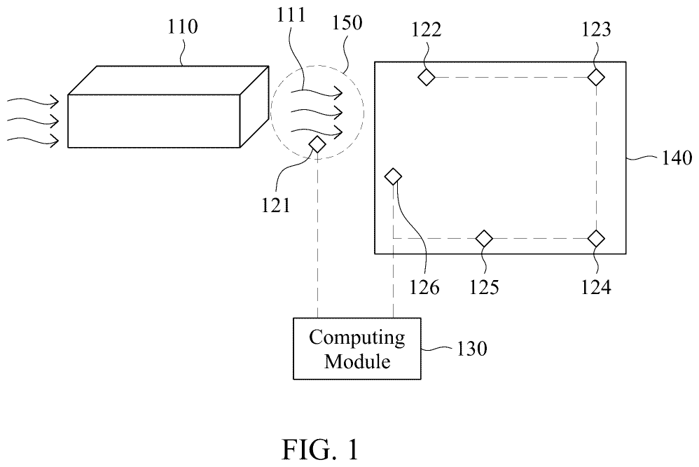

FIG. 1 is a schematic diagram of an environmental anomaly detecting system in accordance with some embodiments of the present disclosure. According to FIG. 1, the environmental anomaly detecting system applied to air detection in an environment 140, includes an air conditioning equipment 110, sensors 121-126, and a computing module 130. In this embodiment, the environment 140 is a cleanroom, and in other embodiments, it may be a factory, an office, or a storage room, but is not limited thereto. The air conditioning equipment 110 is used for providing the air flow 111 to the environment 140. The air conditioning equipment 110 may include such as a heater, a humidifier, a compressor, a fan, a cooling tower, and a cold water valve, but is not limited thereto. The sensors 121-126 may be such as a temperature sensor, a humidity sensor, an atmosphere pressure sensor, but is not limited thereto. In this embodiment, the sensor 121 is deployed in an intake area 150 of the air conditioning equipment 110, and the air flow 111 enters the environment 140 through the intake area 150, while other sensors 122-126 are deployed in the environment 140, but the number and the deploy position of the sensors are not limited. The computing module 130 may be such as a personal computer, a notebook, a server, an industrial computer, a control center, a central processor, or any element or electronic device with computational capabilities. The computing module 130 communicatively connects to the sensors 121-126, and the communicative connection may be implemented via any wire or wireless method. The computing module 130 is used for performing an environmental anomaly detecting method. The detailed explanation of the method is described as following.

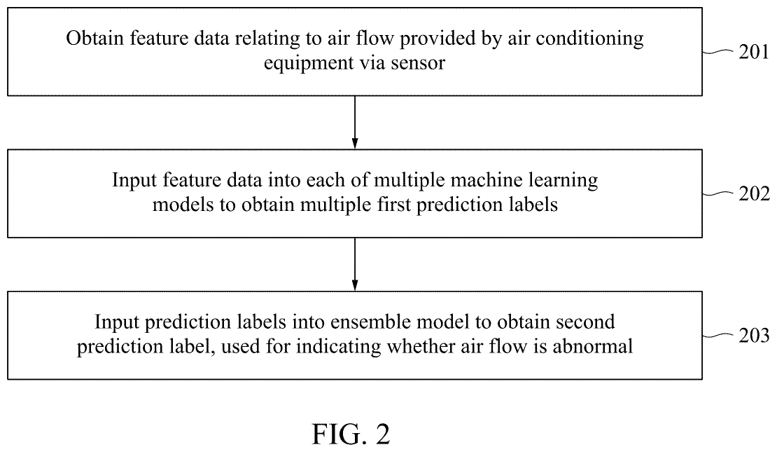

FIG. 2 is a schematic flowchart of an environmental anomaly detecting method in accordance with some embodiments of the present disclosure. According to FIG. 2, in the step 201, feature data relating to the air flow 111 provided by the air conditioning equipment 110 is obtained via the sensor. The feature data, for example, is the temperature and the humidity of the air flow 111. The number of the at least one sensor in the embodiment mentioned previously is 1, and is only deployed in the intake area 150 of the air conditioning equipment 110. In some embodiments, the number of the at least one sensor may be designed as the number bigger than 1, for example, 2, thereby another one of the sensors may be deployed in the environment 140, and the feature data may also include the outdoor temperature and the load rate of the air conditioning equipment 110. If the corresponding sensors 122-126 are deployed in the environment 140, the feature data also includes the temperature and the humidity of the environment 140. Therefore, the environmental anomaly detecting system is able to not only detect the temperature and the humidity of the air flow provided by the air conditioning equipment 110, but also compare to the real situation of the environment 140, for example, the outdoor temperature, and monitor the load rate of the air conditioning equipment 110 at the same time. In this way, it will achieve the more comprehensive and integrated anomaly detection effect, considering both the environment 140 and the load rate of the air conditioning equipment 110 at the same time, rather than relying just a single anomaly detection effect for the temperature and the humidity of the air flow provided by the air conditioning equipment. In some embodiments, the feature data is obtained from the sensor continuously in a time interval. The time interval, for example, may be one or multiple months, weeks, days, or hours, but is not limited thereto. The feature data obtained in the time interval organized into a vector for subsequent steps. In some embodiments, the feature data may be pre-processed with such as a noise reduction, an imputation of missing values, or a normalization.

Therefore, a model may be built with the machine learning algorithm and the historical data of the temperature and humidity sensor, and the model may be used for detecting the changes of the air conditioning equipment more accurately. Also, through the repeated abnormal simulation experiments, the accuracy and real-time performance of the model is validated to apply to various time intervals.

At last, the final anomaly detecting model is built by ensemble learning with blending. This method can combine the advantages of multiple models, not only detecting the anomaly faster but also improving the accuracy.

The detailed explanation of the procedure to perform the machine learning and the ensemble model in the embodiment is described as following.

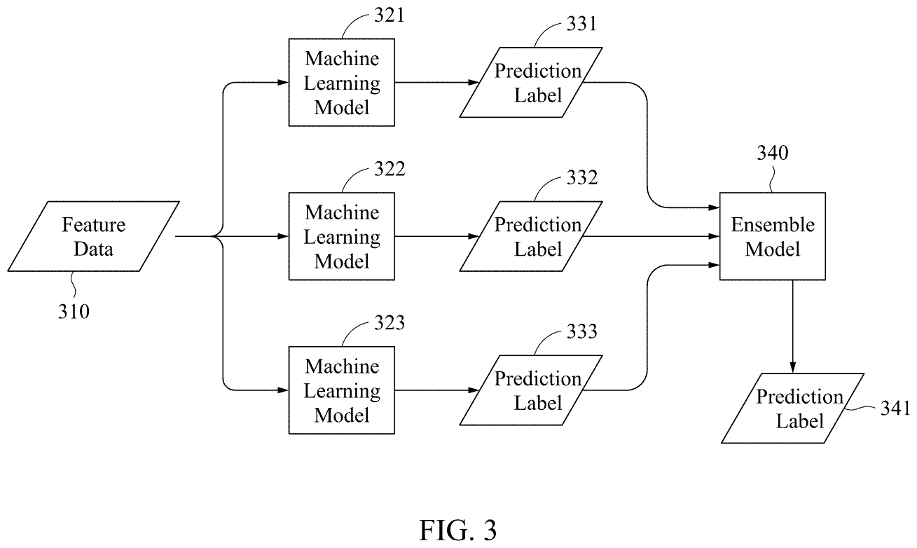

FIG. 3 is a schematic operation diagram of machine learning models and an ensemble model in accordance with some embodiments of the present disclosure. According to FIG. 2 and FIG. 3, in the step 202, the feature data 310 obtained above is inputted into each of the multiple machine learning models 321-323 to obtain multiple prediction labels 331-333. The machine learning models 321-323 may be such as a clustering algorithm, a time series forecasting algorithm, a decision tree algorithm, a multilayer perceptron, a convolutional neural network, or a support vector machine (SVM). The clustering algorithm may be Density-Based Spatial Clustering of Applications with Noise (DBSCAN), and this method can automatically classify data to multiple groups and determine a low density group as an abnormal class to effectively identify high-density regions and exclude noise points. Furthermore, for example, Ordering Points To Identify the Clustering Structure (OPTICS), Hierarchical Density-Based Spatial Clustering of Applications with Noise (H-DBSCAN), Local Outlier Factor (LOF), Connectivity-Based Outlier Factor (COF), and One-Class SVM may also be used. One of the forecasting algorithms is FBprophet, an open source built by Facebook, which is an additive time series decomposition technique and can decompose time series into seasonal, trend, and residual components, then perform a prediction with an adaptive regression model. Furthermore, for example, Autoregressive Integrated Moving Average model (ARIMA) and Moving Average (MA) may also be used. The decision tree algorithm may use Isolation Forest or Random Forest or Random Forest. The concept of Isolation Forest is to partition the training set into multiple subsets using random trees (binary trees), and as the abnormal values are usually sparsely distributed and far from high-density groups, they tend to be isolated at an early stage easier than the abnormal values of data are detected. In Random Forest, multiple decision trees are constructed, and the random feature selection is introduced, i.e., the best feature is selected form a random subset of a feature space at each node splits. After constructing all decision trees, the test samples are classified/regressed. Each decision tree makes an independent detection, and a vote is casted based on all tree output results to choose the class/regression value with the highest votes.

The prediction labels 331-333 represent whether the air flow 111 is abnormal. In the training stage, any component or parameter of the air conditioning equipment 110 may be deliberately adjusted to generate the ground truth label for anomaly. For example, the heater, the humidifier, and/or the cold water valve of the air conditioning equipment 110 may be turned off, or the target temperature and the humidity may also be adjusted to the abnormal range. The corresponding ground truth label at this time is “abnormal.” In this embodiment, the prediction labels 331-333 are discrete labels which are “1” or “0”, presenting abnormal or normal. In other embodiments, the prediction labels 331-333 may also be continuous values, presenting the abnormal probability of the air flow. In other words, the machine learning model 321-323 may be used for classification or regression, but is not limited thereto.

In the step 203, the prediction labels 331-333 are inputted into the ensemble model 340 to obtain the prediction label 341, which is used for indicating whether the air flow is abnormal. The ensemble model 340 is used for combining the outputs of multiple machine learning models 321-323 to generate a more accurate output. For example, each of the machine learning models 321-323 may be assigned a weight, and the ensemble model 340 sums the multiplication of each of the weights and each of the prediction labels 331-333 of the machine learning models 321-323 to obtain a prediction value, which is presented by Equation (1):

$$\hat{y} = {\sum }_{x} ( {y}_{x} \times {w}_{x} ) , \qquad ( 1 )$$

where ŷ represents the prediction value. x is a positive integer, yₓ is the xₜₕ prediction label of the prediction labels 331-333, and wₓ is the weight corresponding to the x^{th} machine learning model. In some embodiments, the weights wₓ of the machine learning models 321-323 are assigned according to the accuracy of each of the machine learning models 321-323 that the models with higher accuracy are assigned the higher weights. Specifically, in the training stage, each feature data forms a sample, and these samples are classified into the “abnormal” or “normal” class by the machine learning models 321-323 then the classification indicator of each machine learning model may be calculated based on the classification result. This classification indicator is calculated by Equations (2)-(5) as follows:

$$S = \frac{1}{m} {\sum }_{i = 1}^{n} s ( i ) , \qquad ( 2 )$$

$$s ( i ) = \frac{b ( i ) - a ( i )}{max ( a ( i ) , b ( i ) )} , \qquad ( 3 )$$

$$a ( i ) = \frac{1}{n - 1} {\sum }_{j \neq i}^{n} distance ( i , j ) , and \qquad ( 4 )$$

$$b ( i ) = min ( \frac{1}{{n}_{k}} {\sum }_{{j}_{k} = 1}^{{n}_{k}} distance ( i , {j}_{k} ) , k = 1 , 2 , … ) , \qquad ( 5 )$$

where S is the classification indicator of one of the machine learning models, i, j, jₖ, and k are positive integers, m represents a number of all samples. n represents a number of a class to which the i^{th} sample belongs and the i^{th} sample and the j^{th} sample belong to the same class, nₖ represents a number of a k^{th} class and the i^{th} sample and the jₖ^{th} sample belong to different classes, and distance( ) is used for calculating a distance between two samples, for example, calculating an Eurasian distance between the vectors generated from the feature data. In other words, Equation (5) is used for calculating the distance between two samples belonging to different classes, and the greater distance indicates a greater separation between the two classes that the bigger the calculated value b (i) indicates a better classification result. Equation (4) is used for calculating the distance between two samples belonging to the same class, and the smaller distance indicates a higher concentration of the samples in the same class that the smaller the calculated value a (i) indicates a better classification result. Equation (3) combines the value a (i) and b (i), and the bigger the value b (i) and the smaller the value a (i), the bigger the calculated value s (i), indicating a better classification result. At last, Equation (2) calculates an average of the values s (i) corresponding to all samples as the classification indicator S of a machine learning model. Each of the machine learning models 321-323 corresponds to an individual classification indicator S, and the bigger the classification indicator S indicates a better classification result.

The value range of the classification indicator S is [−1,1], and each of the classification indicators may be added a constant (for example, 1) to adjust the value range of the classification indicator S to [0,2] in order to calculate the weights of the machine learning models 321-323, and the bigger the classification indicator, the bigger the weight to be assigned. In some embodiments, the weight is calculated by Equation (6):

$${w}_{x} = \frac{{S}_{x} + 1}{{\sum }_{x} ( {S}_{x} + 1 )} , \qquad ( 6 )$$

where Sₓ is the classification indicator of the x^{th} machine learning model. In other words, Equation (6) adds 1 to each classification indicator first then divides it by the sum of classification indicators corresponding to all machine learning models 321-323, to perform a normalization and calculate the weight wₓ.

In some embodiments, the weights of the machine learning models 321-323 may be determined by iteration, and the weights of the samples are adjusted at each iteration. Specifically, as described below,

$${w}_{x}^{i}$$

represents the weight of the x^{th} machine learning model at the i^{th} iteration. In this embodiment, the above equation (1) may be rewritten as Equation (7):

$$\hat{y} = {\sum }_{i} {\sum }_{x} {y}_{x} \times {w}_{x}^{i} . \qquad ( 7 )$$

As described below, βₙ represents the weight of the n^{th} sample, and all the weights are assigned to a same value at the 1^{st} iteration. Next, the training samples are inputted into the machine learning model to calculate the error rate of each machine learning model, which is defined as the multiplication of the weights of the samples and the classification results, represented by Equation (8):

$${ε}_{x} = {\sum }_{n} {β}_{n} \times {f}_{n} ( n ) , \qquad ( 8 )$$

where fₓ(n) represents the classification result of the n^{th} training sample obtained by the x^{th} machine learning model. When the classification is correct, fₓ(n)=0, while the classification is wrong, fₓ(n)=1. Then the weight

$${w}_{x}^{i}$$

is calculated based on the error rate represented by Equation (9):

$${w}_{x}^{i}$$

At last, the weights βₙ are renewed according to the classification result of all machine learning model at all iterations represented by Equation (10):

$${w}_{x}^{i} = 0.5 \times ln ( \frac{( 1 - {ε}_{x} )}{{ε}_{x}} ) . \qquad ( 9 )$$

where β′ₙ represents the renewed weight. \hat{f}ₓ(n) represents the classification result of the weighted sum of the n^{th} sample obtained by all machine learning models 321-323, which is set to 0 when the classification is correct and set to 1 when the classification is wrong. γ is an integer. After the weights βₙ are renewed, all the weights βₙ are normalized, for example, divided by the sum of all the weights βₙ, then the next iteration (i=i+1) is performed. In Equation (8), the error rate is calculated based on the weight of the sample, thus the sample with the bigger weight contributes more to the error rate. In Equation (9), the weight

$${β}_{n}^{′} = {β}_{n} \times {e}^{- γ \times {\hat{f}}_{x} ( n )} , \qquad ( 10 )$$

is determined according to the error rate Ex, and when the error rate is smaller the weight

$${w}_{x}^{i}$$

becomes bigger. At last, the weight of the sample is renewed by Equation (10). If the classification is wrong, the weight is increased, and if the classification is correct, the weight is decreased, so that the sample misclassified is previously focused on in the next iteration. Here, a preset number of the iterations may be set, or the iteration may be set to stop when the error rate is lower than a value. In this way, multiple weak classifiers are combined to a strong classifier by the combination of not only the multiple machine learning models but also the classification results of the multiple iterations.

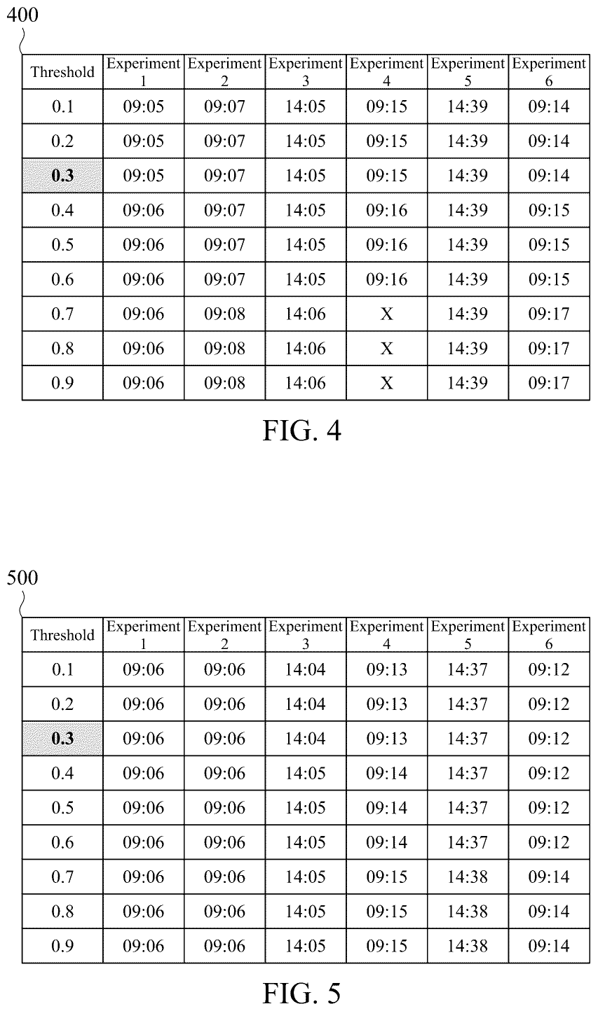

No matter in Equation (2) or (7), after calculating the prediction value ŷ, the prediction label 341 is generated by determining whether the prediction value ŷ is higher than a threshold, for example, when the prediction value y is higher than the threshold, the prediction label 341 is set to “1” for anomaly, or the prediction label 341 is set to “0.” The value range of the threshold is [0,1], which may be set according to the experiment result in this embodiment. FIG. 4 and FIG. 5 are schematic diagrams of experiment results in accordance with some embodiments of the present disclosure. According to FIG. 4 and FIG. 5, the diagram 400 relates to the anomaly detection of the temperature, and the diagram 500 relates to the anomaly detection of the humidity. In the experiment 1, the air conditioning equipment 110 is turned off at 09:00, and the anomaly can be detected in few minutes after the equipment turned off. For example, the temperature anomaly is detected at 09:05 when the threshold is set to 0.1-0.3, the temperature anomaly is detected at 09:06 when the threshold is set to 0.4-0.9, the temperature anomaly is detected at 09:06 when the threshold is set to 0.1-0.9, and so on. In the experiment 2, the air conditioning equipment 110 is turned off at 09:00. In the experiment 3, the air conditioning equipment 110 is turned off at 14:00. In the experiment 4, the air conditioning equipment 110 is turned off at 09:10. In the experiment 5, the air conditioning equipment 110 is turned off at 14:30. In the experiment 6, the air conditioning equipment 110 is turned off at 09:10. According to the experiment results in the diagram 400 and the diagram 500, in some embodiments, the thresholds are set to less than or equal to 0.6, then all the experiment results show that the correct anomaly detection results are obtained and the alarm stage is entered. Preferably, in some embodiments, the threshold is set to less than or equal to 0.3 to detect the temperature and the humidity anomalies earlier (about 1 to 2 minutes earlier) and the alarm stage is entered earlier.

When the anomaly of the air flow is determined, the computing module 130 delivers a massage via any human-machine interface or equipment, for example, by showing specific words, numbers, or images on a screen; emitting light through a luminous source; making a specific sound through a speaker; or sending a text massage to a relevant person's mobile phone. In this way, the relevant operators can learn about the anomaly of the air flow 111 then arrange the equipment maintenance.

Due to the temperature and humidity data may be changed by the season and weather, the trained machine learning models 321-323 and ensemble model 340 mentioned above require adaptive adjustments. Each machine learning model includes multiple model parameters, for example, the weights of neurons in the neural networks, and the thresholds used for determining which branch to take in the random forest, which need to be recalculated to meet the environment conditions after the changes. Similarly, the classification indicators and the weights in the ensemble model 340 also need to be recalculated. In some embodiments, the trained machine learning models 321-323 and the ensemble model 340 mentioned above may be re-trained according to new feature data at every time interval (for example, a few weeks, months, or any time) to renew the model parameters, the classification indicators Sₓ and the weights wₓ. Therefore, the model parameters adjustment is performed when unexpected deviations occur in the data (for example, cold snaps, foehn winds) and the model is re-adjusted according to the new data. In other words, re-training the model regularly enables the model health to be maintained at a high level and ensures the models to adapt the changing environment.

More specifically, this embodiment uses the historical data 2 weeks before the forecast date as the training set to build the models, and because the difference in the model parameters affects the accuracy of the anomaly determination, at every renewal of the model, the best model parameter is selected by nested cross-validation to improve the accuracy of the model. To ensure the accuracy of the model is not decreased by shifts or changes in data distribution, these machine learning models are also regularly renewed, re-trained, and re-adjusted according to the new data to obtain better performance in the new data.

The steps in FIG. 2 may be implemented as multiple program codes or circuits, but is not limited thereto. Additionally, the method in FIG. 2 may be implemented along or with the embodiment mentioned above. In other words, other steps may also be added in the steps in FIG. 2.

In the environmental anomaly detecting system and the environmental anomaly detecting method disclosed in this embodiment, through inputting the first prediction label of each machine learning model into the ensemble model, and obtaining the second prediction label by integrating with blending ensemble method to indicate whether the air flow is abnormal, the prediction is performed to implement an effective detection and to detect and prevent the environmental anomalies earlier.

Therefore, when the environmental anomaly detecting system is deployed in the manufacturing site or the production line, the following two technical effects can be achieved:
1. Abnormal event warning: The early warning is performed before the temperature and the humidity anomalies happen in the manufacturing site to help the production line to make relevant preparation and take corresponding measures to reduce the possibility of defective products.
2. Products and material quality protection: Most of materials keep their qualities under the specific temperature and humidity control, and damage when the condition is under the standard. Therefore, through the anomaly detecting mechanism, timely adjustment will be performed to protect the products and the qualities of the materials.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. An environmental anomaly detecting system, applied to an air detection in an environment, the environmental anomaly detecting system comprising:
an air conditioning equipment, used for providing an air flow to the environment;
at least one sensor, used for obtaining a feature data relating to the air flow; and
a computing module, communicatively connecting to the at least one sensor, used for inputting the feature data into each of multiple machine learning models to obtain multiple first prediction labels,
wherein the computing module is used for inputting the multiple first prediction labels into an ensemble model to obtain a second prediction label, and the second prediction label is used for indicating whether the air flow is abnormal.

2. The environmental anomaly detecting system of claim 1, wherein a number of the at least one sensor is bigger than 1, and one of the sensors is deployed in an intake area of the air conditioning equipment, and the air flow enters the environment through the intake area, wherein
another one of the sensors is deployed in the environment.

3. The environmental anomaly detecting system of claim 2, wherein the feature data comprises a temperature and a humidity.

4. The environmental anomaly detecting system of claim 3, wherein the computing module is further used for obtaining an outdoor temperature and a load rate of the air conditioning equipment, and the feature data further comprises the outdoor temperature and the load rate.

5. The environmental anomaly detecting system of claim 1, wherein the machine learning models comprise a clustering algorithm, a time series forecasting algorithm, and a decision tree algorithm.

6. The environmental anomaly detecting system of claim 1, wherein the computing module is used for calculating a classification indicator of each of the machine learning models in a training stage, wherein
the computing module adds a constant to the classification indicator to calculate a weight of each of the machine learning models, and
the ensemble model is used for summing a multiplication of each of the weights of the machine learning models and each of the first prediction labels of the machine learning models to obtain a prediction value, and is used for determining whether the prediction value is higher than a threshold to generate the second prediction label.

7. The environmental anomaly detecting system of claim 6, wherein the threshold is set to be less than or equal to 0.6.

8. The environmental anomaly detecting system of claim 7, wherein the threshold is set to be less than or equal to 0.3.

9. The environmental anomaly detecting system of claim 6, wherein the classification indicator is calculated according to the following equations:
$$S = \frac{1}{m} {\sum }_{i = 1}^{n} s ( i ) ,$$
$$s ( i ) = \frac{b ( i ) - a ( i )}{max ( a ( i ) , b ( i ) )} ,$$
$$a ( i ) = \frac{1}{n - 1} {\sum }_{j \neq i}^{n} distance ( i , j ) , and$$
$$b ( i ) = min ( \frac{1}{{n}_{k}} {\sum }_{{j}_{k} = 1}^{{n}_{k}} distance ( i , {j}_{k} ) , k = 1 , 2 , … ) ,$$
where S represents the classification indicator, i, j, jₖ, k are positive integers, m represents a number of the multiple samples, n represents a number of a class to which an i^{th} sample belongs and the i^{th} sample and a j^{th} sample belong to a same class, nₖ represents a number of a kin class and the i^{th} sample and a jₖ^{th} sample belong to different classes, and distance( ) is used for calculating a distance between two samples.

10. The environmental anomaly detecting system of claim 9, wherein the computing module is used for calculating the weights according to the following equation:
$${w}_{x} = \frac{{S}_{x} + 1}{{\sum }_{x} ( {S}_{x} + 1 )} ,$$
where x is a positive integer, Sₓ is the classification indicator of a x^{th} machine learning model, and wₓ is the weight of the x^{th} machine learning model.

11. The environmental anomaly detecting system of claim 6, wherein each of the machine learning models has multiple model parameters, and the computing module is used for re-training the machine learning models and the ensemble model at every preset time interval according to a new feature data to renew the model parameters, the classification indicators, and the weights.

12. An environmental anomaly detecting method, applied to the environmental anomaly detecting system according to claim 1, the environmental anomaly detecting method comprising:
a data capture step for obtaining the feature data of the air flow;
an input step for inputting the feature data into each of the multiple machine learning models to obtain the multiple first prediction labels; and
an ensemble step for inputting the multiple first prediction labels into the ensemble model to obtain the second prediction label, and the second prediction label is used for indicating whether the air flow is abnormal.

13. The environmental anomaly detecting method of claim 12, wherein the feature data comprises a temperature and a humidity.

14. The environmental anomaly detecting method of claim 12, wherein the machine learning models comprise a clustering algorithm, a time series forecasting algorithm, and a decision tree algorithm.

15. The environmental anomaly detecting method of claim 12, further comprising:
calculating a classification indicator of each of the machine learning models in a training stage;
adding a constant to the classification indicator to calculate a weight of each of the machine learning models; and
summing a multiplication of each of the weights of the machine learning models and each of the first prediction labels of the machine learning models to obtain a prediction value, and determining whether the prediction value is higher than a threshold to generate the second prediction label with the ensemble model.
